(19) United States
(12) Patent Application Publication
(10) Pub. No.: US 2007/0236790 A1
(43) Pub. Date: Oct. 11, 2007

(54) Night vision attachment mountable on a firearm and intended for a sighting telescope

(76) Inventors: Oscar Turienzo, Balgach (CH); Giorgio Salvo, Diepoldsau (CH); Dusan Zadravec, Rebstein (CH); Hans-Peter Kobelt, Gais (CH)

Correspondence Address: McCulloch PLC, 1st Floor, 5291 Colony Drive North, Saginaw, MI, 48638, US

(21) Appl. No.: 11/401,192

(22) Filed: Apr. 10, 2006

(51) Int. Cl. G02B 23/00

(52) U.S. Cl. 359/399; 359/431

(57) ABSTRACT

A night vision attachment (NSV) mountable on a firearm and intended for a sighting telescope (ZF), comprising an objective (1) of the night vision attachment, a low-light-level amplifier (2), an optical assembly (3) and an eyepiece (4) of the night vision attachment, is formed in such a way that a beam offset between radiation entering through the objective (1) of the night vision attachment and emerging through the eyepiece (4) of the night vision attachment is achieved by means of the optical assembly. The offset takes place from the optical axis (A1) of the objective (1) of the night vision attachment on to the optical axis (A2) of the eyepiece (4) of the night vision attachment, the latter corresponding substantially to the optical axis (A2) of the sighting telescope (ZF) downstream of the attachment. Consequently, night vision attachment (NSV) and sighting telescope (ZF) can be mounted as close as possible to the housing of the firearm.

The invention relates to a night vision attachment mountable on a firearm and intended for a sighting telescope according to the preamble of claim 1.

A night vision attachment mountable on a firearm and intended for a sighting telescope is connected in front of the sighting telescope for night operation thereof, which telescope can be likewise fixed to the firearm in a known manner. Because in general only optical radiation of low intensity is available in night operation, observations by means of a sighting telescope optical system in the form of a day vision optical system can no longer be carried out. With the night vision attachment, which has a night vision optical system for receiving and for amplifying radiation of low intensity, night operation of the sighting telescope is permitted by connecting the night vision attachment in front of the sighting telescope; for example, night vision attachment and sighting telescope are connected to one another by fixing to the weapon, by plugging on or by screwing on. In this context, the term night is not to be understood as meaning a period of time but a situation with light conditions which no longer permit observation using a customary day vision optical system. The night vision attachment connected in front of the sighting telescope has a large objective of the generic type for receiving as high a proportion as possible of radiation and a low-light-level amplifier for amplifying the radiation. The radiation received in the attached fast night vision objective and amplified in the low-light-level amplifier is then projected by an eyepiece of the attachment into the sighting telescope objective, from where the radiation, after passing through the customary telescope optical system, is accessible to a marksman as an image. In day operation, the attachment is removed again and the sighting telescope is used as such, this sighting telescope remaining—on the firearm—in the mounted position in order to avoid putting the arrangement or the orientation relative to the weapon out of adjustment.

Sighting telescopes are mainly used for military purposes, the sighting telescope being mounted on the firearm, in particular a gun, for aiming at targets. For night operation—as described above—the night vision attachment is connected in front of the sighting telescope and likewise mounted on the firearm. In particular, sighting telescopes—and night vision attachments—are used on marksmen's guns. A marksman's gun has, for example, a total length of more than 1 m and, for example, a barrel length of about 0.7 m. In the case of these guns, extremely high accelerations occur on shooting. The energy of the backward movement of the weapon parts—the recoil—is absorbed by the inertia of the weapon and by the marksman.

When night vision attachment and/or sighting telescope are mounted in an unstable manner, for example too high, on the firearm, an imbalance occurs at the recoil caused by the translational and rotational momentum of the shot, and components of the system may break off. This constitutes a safety risk for the marksman. The—camouflaged—marksman is also in danger if he has to perform movements, for example for operating the night vision attachment, which make it possible for the enemy to locate him. In the case of a night vision attachment arranged in front of the sighting telescope, the night vision attachment is present outside the—convenient—range of the marksman, so that the latter has to perform a conspicuous movement if he wants to actuate a operating device on the night vision attachment.

In order to keep the arrangement and orientation of sighting telescope and night vision attachment on the firearm as stable as possible, they are generally mounted by means of specially formed rails or plug connections. Slight orientation errors during mounting lead to a skew position of the optical axis of the telescope and of the night vision attachment relative to the bore axis of the barrel of the firearm. Fixing in a manner which is as stable as possible is moreover required in order to withstand the forces occurring during the shooting process and furthermore in order to make it easier for the marksman to handle the firearm—with the optical attachment.

Thus, for example, the activity of a marksman often requires him to remain in the same position for hours with the gun in the shooting position and the sighting telescope to his eye. In order to make it easier for the marksman to hold such a position, it is advisable to arrange the telescope as close as possible to the weapon. If the telescope is mounted in an elevated position, the marksman must constantly “stretch his neck” when observing and sighting. As a result of an inconvenient posture, on the one hand, the safety of the marksman, who should as far as possible not move in order to avoid being located by the enemy, is endangered and, on the other hand, the health of the marksman is endangered by the unnatural posture. An elevated arrangement also impairs the stability of the arrangement.

There are known rails or plug connections which serve for supporting the sighting telescope over its entire length and which permit fixing as close as possible to the body of the gun. However, the arrangement and fixing together with the night vision device are problematic. The night vision objective of the attachment is formed larger than the day vision objective of the sighting telescope, owing to the abovementioned light intensity. For example, the objective of the night vision attachment has a diameter of about 80 mm and the objective of the sighting telescope has a diameter of about 40 mm. Accordingly, the respective housings—the housing of the night vision attachment and the housing of the sighting telescope—which surround the respective optical systems differ in their size. The radiation emerging from the night vision attachment substantially along the optical axis of the attachment is therefore not on the optical axis of the sighting telescope, which axis—owing to the size difference mentioned—is offset in height relative to the attachment axis. Consequently, the combined arrangement is complicated, in particular with regard to its stability.

Arrangements are known in which, for compensating the size difference, the sighting telescope is mounted in an elevated position in such a way that its optical axis coincides with the optical axis of the night vision attachment which is connected in front and, owing to the large objective, is higher. Alternative arrangements mount the night vision attachment on the sighting telescope in order thus to be able to mount the sighting telescope as close (low) as possible to the firearm. The radiation received in the night vision attachment is then reflected by means of a periscope-like optical system into the objective of the sighting telescope. Such arrangements extended in height are, however, imbalanced particularly during recoil due to a shot and are inconvenient systems for the marksman. As a result of the forces acting on the arrangement, it is even possible for the night vision attachment to break off. Furthermore, this arrangement accordingly has a large parallax—for example of 7 cm to 10 cm—which the marksman additionally has to take into account as a correction factor in his ballistic calculation. Moreover, the high arrangement endangers the camouflage of the marksman.

An object of the invention is to provide a night vision attachment which can be fixed on a firearm and is intended for a sighting telescope, which night vision attachment is formed in such a way that it can be connected in front of the sighting telescope and that a stable arrangement of sighting telescope with night vision attachment connected in front on the firearm is permitted.

A further object is to provide a night vision attachment which can be fixed on a firearm and is intended for a sighting telescope, with improved handling properties and operability.

These objects are achieved by the features of claim 1 or the dependent claims or the solutions are further developed.

According to the invention a night vision attachment for a sighting telescope is formed in such a way that an axial offset of the radiation entering the objective of the night vision attachment is achieved in the attachment itself, the offset being in the direction of the optical axis of the sighting telescope downstream of the attachment. Because the radiation is offset in the direction of the optical axis, in particular on to the optical axis, of the telescope or of the objective of the telescope in the night vision attachment itself, it is possible to arrange attachment and telescope so that the respective bottoms of the housings rest substantially directly on the same support surface, for example a rail, and thus to mount the entire arrangement as close as possible to the housing of the firearm, in particular hand-holdable or hand-held firearm. An extremely stable system which furthermore permits a more pleasant operating posture for the marksman is thus provided.

The possibility of the more pleasant operating posture is achieved by the arrangement as close as possible to the weapon housing. As a result of the radiation offset in the night vision attachment the radiation is guided in the attachment itself onto an optical axis which substantially corresponds to the optical axis of the sighting telescope. The attachment can therefore be connected directly in front of the telescope and fixed in such a way that the bottom of the attachment and the bottom of the telescope lie in substantially the same horizontal plane, the side to be mounted on the weapon being defined as the bottom. Thus, neither elevated mounting of the telescope in order to bring its optical radiation-receiving axis into coincidence with the optical radiation exit axis of the night vision attachment nor a periscope-like reflective arrangement for reflecting the night vision radiation into the telescope is required. Because the radiation emerging from the attachment eyepiece is already substantially on the optical axis of the—radiation-receiving—telescope objective, it can be received directly and in collimated form by it.

The designation sighting telescope includes telescopes which can be fixed on a firearm and are formed for sighting a target so that it will be reliably struck. For sighting, the telescope generally has a cross hair which is adjustable laterally and in height. By appropriate adjustment and shooting of the weapon the marksman determines the operating parameters of the telescope and firearm which enable him to strike the target in a controlled manner. In order to keep the adjustment effort as small as possible, the arrangement of the sighting telescope mounted for day operation on the weapon is retained in night operation. The night vision attachment is attached in front of the mounted gun for night operation or is removed from the gun for day operation. The arrangement on the firearm is chosen as close as possible to the weapon housing, inter alia for reasons of stability. With a night vision attachment connected in front of the sighting telescope—or a sightings telescope downstream of the night vision attachment—an arrangement is defined in which the attachment or the attachment housing is arranged—substantially directly—in front of the sighting telescope or the telescope housing, so that the radiation emerging from the attachment can be received by means of the telescope without intermediate optical components. With a specified 1× magnification of the night vision attachment, the exact angular position of night vision attachment and telescope—the parallelism of the optical axes of night vision attachment and telescope—is not critical, so that the line of sight or accuracy of strike in the night is not adversely affected.

Advantageously, sighting telescope and night vision attachment are formed in such a way that they can be connected in a simple manner by means of plugging, “clicking” or screwing.

The optical arrangement of the night vision attachment according to the invention comprises an objective of the night vision attachment, a radiation amplifier, an optical assembly for radiation offset, which advantageously also acts as an image inversion system, and an eyepiece of the night vision attachment. However, the attachment may also have further optical components, for example for guidance and/or correction of the beam path.

The sighting telescope is designed in a customary manner. It has a telescope objective for receiving radiation, for example having a diameter of from 40 mm to 50 mm. It furthermore has a telescope eyepiece through which the marksman or an observer can view the received radiation as an image. In addition, the sighting telescope generally has—as mentioned above—at least one crosshair.

In night operation, the night vision attachment is connected in front of the sighting telescope. Radiation emanating from an object or a scene is collected in the objective of the night vision attachment and amplified in the radiation amplifier. In the case of a low-light-level amplifier as a radiation amplifier, the objective of the night vision attachment focuses the radiation on to the entry window thereof. In the low-light-level amplifier, the radiation is electronically amplified and appears as a brighter visible image on the exit window of the amplifier. By means of the eyepiece of the night vision attachment, the amplified image radiation is projected on to the telescope objective and passed from there by means of optical telescope components to the observer.

In the night vision attachment according to the invention, the radiation received in the objective of the night vision attachment is passed along a first axis to an optical assembly in the night vision attachment. By means of this optical assembly, the radiation is guided from the first axis—which substantially corresponds to the optical axis of the attachment objective—onto a second axis substantially parallel thereto. This parallel second axis substantially corresponds to the optical axis of the eyepiece of the night vision attachment and also to the optical axis of the sighting telescope.

By means of an appropriately formed optical assembly, for example a Porro system of the 2^{nd} type, for example, a beam offset of 25 mm or more of the radiation passed substantially along the optical axis of the attachment objective is achievable for an objective of a night vision attachment, which objective has a diameter of about 80 mm—the radiation offset in this manner can then be received, for example, substantially on the optical axis of a 40 mm objective of the sighting telescope if the respective bottoms of housings of night vision attachment and sighting telescope are in the same horizontal plane. The formation and arrangement of the optical assembly is chosen in particular so that as high a proportion as possible of the radiation collected in the attachment objective is passed to the attachment eyepiece and further to the sighting telescope. In particular by means of the formation according to the invention radiation can be delivered to the eyepiece of the sighting telescope in a quantity such that the exit pupil of the eyepiece of the sighting telescope is substantially completely illuminated. This facilitates the positioning of the eye at the eyepiece. In comparison, in known systems in which only a small area of the exit pupil is illuminated, precise positioning of the eye is necessary in order to be able to recognize the image.

The optical assembly for axial offset of the radiation is arranged, for example, between radiation amplifier and eyepiece of the night vision attachment. Advantageously, the assembly is additionally formed as an image inversion system. By forming the optical assembly as an image inversion system it is possible in addition to improve the image quality since, for example, a non-inverting image amplification tube can then be used as a radiation amplifier. If on the other hand—as is often customary—the inversion of the image is carried out in the amplifier, a poor image quality often results, for example with the use of fiber optics in the amplifier with reduced resolution through the fiber window.

According to the invention, a prism and/or lens system is used as an optical assembly. With a Porro system of the 2^{nd} type both the beam offset and the image inversion can be achieved.

The night vision attachment according to the invention in combination with a sighting telescope is suitable in particular for assault rifles and marksmen's guns, as described above. As a result of the formation according to the invention, night vision attachment and sighting telescope can be mounted close to the gun housing, with the result that the system is more compact, more convenient and more stable. With the night vision attachment according to the invention, it is possible to provide a marksman who uses the sighting telescope with the night vision attachment on a firearm with an arrangement improved in particular with regard to convenience and safety.

For further improved operability of a night vision attachment for a sighting telescope, at least one first and/or second mechanical switching device/operating device for a night vision attachment for safe operation by the marksman is furthermore provided within the scope of the invention. The first or second mechanical switching device has a cordless connection or cable connection to a first and/or second electronic switching device in the attachment. By means of the electronic switching device, settings of the night vision attachment can be changed in a known manner; for example it is possible to switch the electronic radiation amplifier on and off and to regulate the amplifier power. The first mechanical operating device may be in the form of a rotary and/or key switch and is mounted, for example, on the housing of the night vision attachment. The second mechanical operating device can likewise be in the form of a switch, such as a rotary and/or key switch. Since, owing to the great length—as mentioned above—of the gun and hence arrangement of the night vision attachment generally outside the convenient range of the marksman, an undesired movement is required for operating a switching device on the attachment housing, the second mechanical switching device is arranged away from the attachment housing. In particular, the second mechanical switching device is arranged away from the housing of the attachment by a distance approximately corresponding to the longitudinal dimension of the sighting telescope, for example close to the trigger of the gun or near or on the marksman. The second mechanical switching device according to the invention therefore permits, if required, actuation directly at the marksman. The design of the second mechanical switching device may comprise, for example, a cable arranged on or around the sighting telescope and having a control knob, the control knob being arranged in a position convenient for the marksman. The cable connects the control knob, for example, to the first electronic switching device. The night vision attachment may have a second electronic switching device, for example a microswitch, in which case the first electronic switching device can be actuated by means of the first mechanical switching device, and the second electronic switching device by means of the second mechanical switching device. Likewise, the night vision attachment can also be formed only with one electronic and two mechanical switching devices, the electronic switching device being capable of being actuated by means of the first and/or second mechanical switching device. Advantageously, the second mechanical switching device is removable and exchangeable and can be led to the marksman on the right or left for good operability both for right-handed and for left-handed marksmen.

The night vision attachment according to the invention is described in more detail below, purely by way of example, with reference to working examples shown schematically in the drawings. Specifically,

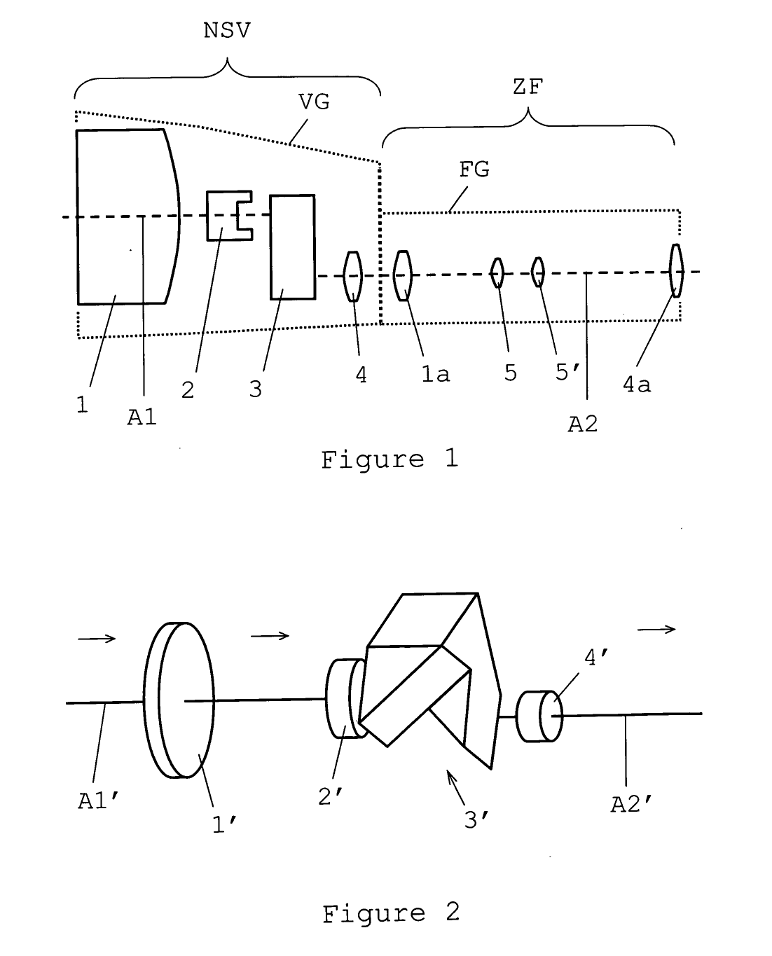

FIG. 1 shows a sighting telescope according to the invention, having a night vision attachment;

FIG. 2 shows a diagram of optical components of a night vision attachment according to the invention;

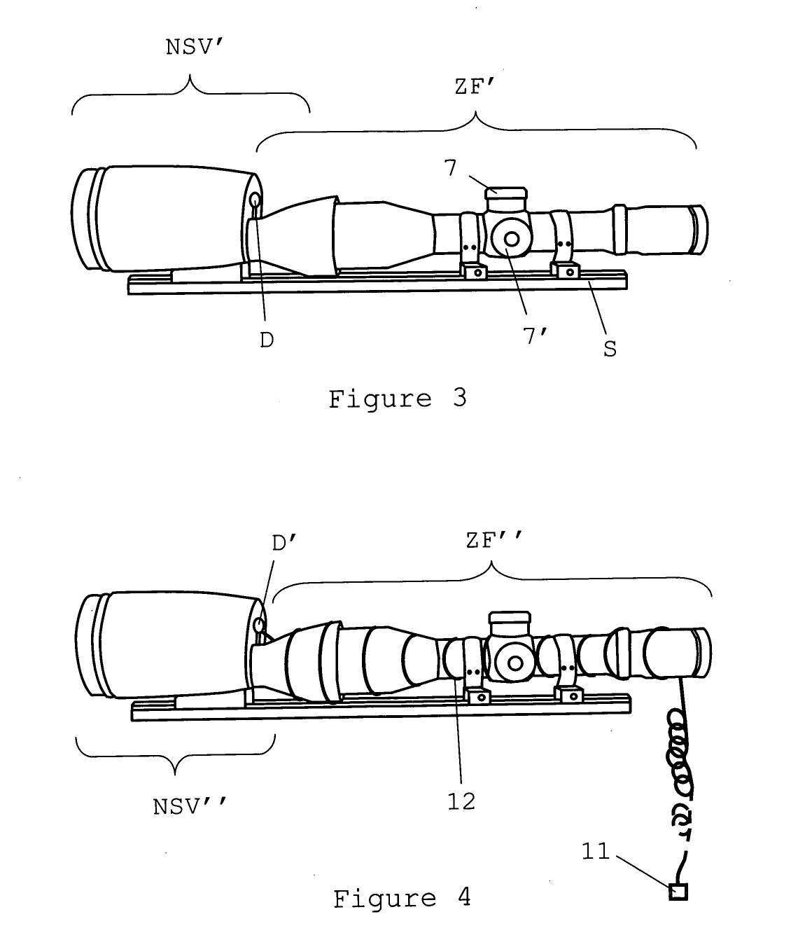

FIG. 3 shows a sighting telescope with night vision attachment, mounted on a rail;

FIG. 4 shows a sighting telescope with night vision attachment and a first and second mechanical switching device for the night vision attachment;

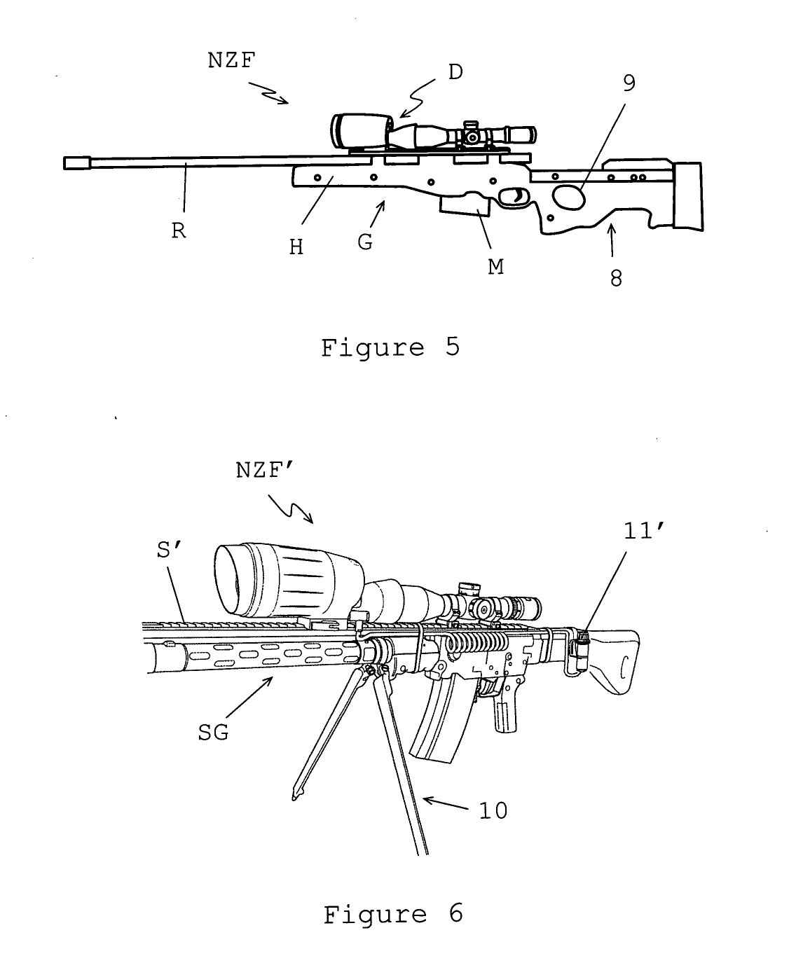

FIG. 5 shows the arrangement from FIG. 3 mounted on a gun;

FIG. 6 shows a working example of a night vision attachment according to the invention with a sighting telescope and an external mechanical switching device according to the invention mounted on a gun;

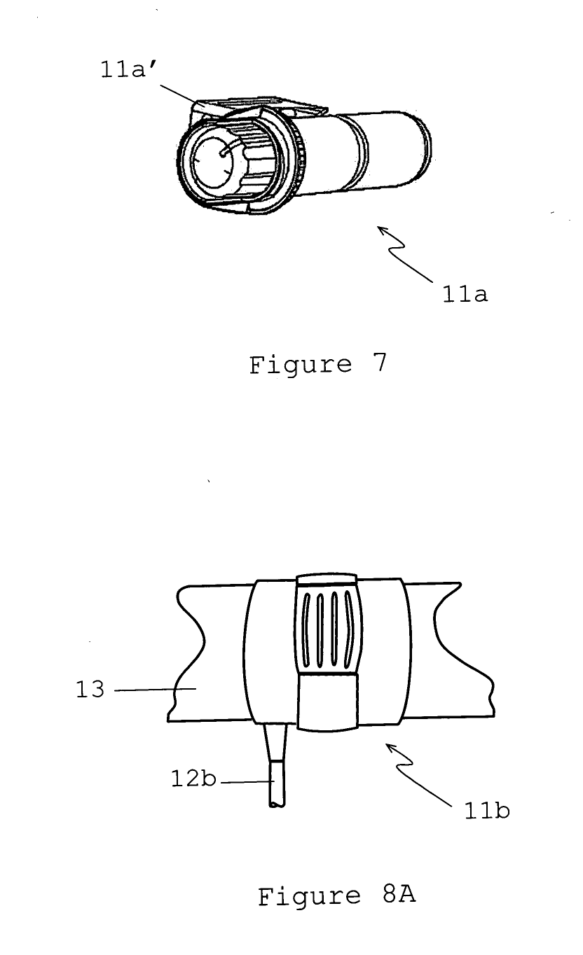

FIG. 7 shows a working example of an external mechanical switching device according to the invention for a night vision attachment;

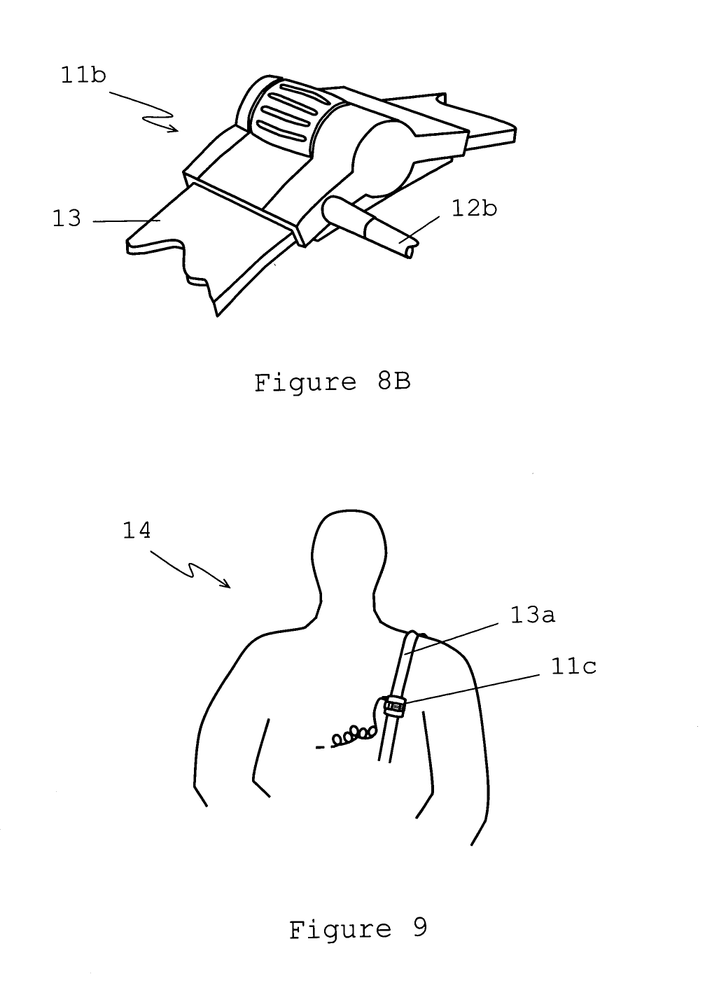

FIG. 8 shows, in two part FIGS. 8A and 8B, a further working example of an external mechanical switching device according to the invention for a night vision attachment;

FIG. 9 shows a marksman with an external mechanical switching device according to the invention on a shoulder strap.

FIG. 1 schematically shows the diagram of optical components of a night vision attachment NSV and of a sighting telescope ZF downstream thereof. The attachment housing VG and the telescope housing FG are indicated by dotted lines. The diagram of the figure and also the diagrams of the subsequent figures are not to be regarded as being to scale. Thus, for example, the sighting telescope ZF is shown greatly shortened in comparison with the attachment. The dashed lines designate the optical axis A1 of the objective 1 of the night vision attachment and the optical axis A2 of the eyepiece 4 of the night vision attachment and also said axis of the sighting telescope ZF. The optical axes A2 of eyepiece 4 of the night vision attachment and of sighting telescope ZF correspond to one another. The night vision attachment NSV can be detachably connected to the sighting telescope ZF by simply pushing on. Under day vision conditions, observations with the sighting telescope ZF can be carried out without the attachment. In the case of night vision, object radiation which emanates from objects to be observed or a scene to be observed and may originate, for example, from the moon, stars or artificial light emissions, such as municipal lights or street lights or scattering—for example by clouds—of artificial light emissions is collected by means of the objective 1 of the night vision attachment. Since the available object radiation may be very low, as fast and hence as large as an objective as possible is required. The formation of the objective is in general a compromise between size and weight and compactness of the arrangement. A large attachment objective constitutes a relatively large and inconvenient load to carry. Furthermore, a relatively large objective requires a longer beam path or a larger number of optical components for focusing the collected radiation, which components, however, result in radiation losses. In the night vision attachment NSV in the working example shown, the object radiation received by the objective 1 of the night vision attachment is focused along a first axis—the optical axis A1 of the objective 1 of the night vision attachment—onto the entry window of a low-light-level amplifier 2 and appears as an amplified image at the exit window of the amplifier. This image is passed further along the first axis to an optical assembly 3, which optical assembly 3 acts firstly as an image inversion system and secondly as a deflection system for deflecting the image radiation onto the optical axis A2 of the attachment eyepiece 4 and sighting telescope ZF. The optical axis A2 is parallel and offset in height relative to the first axis. Owing to the beam offset of the object radiation in the attachment module itself onto the optical axis A2 of the sighting telescope ZF, it is possible to fix attachment and sighting telescope ZF in the same—horizontal—plane. The radiation from the eyepiece 4 of the night vision attachment is received in the telescope objective la and passed via further telescope components 5, 5′ to the telescope eyepiece 4a. An observer can view a non-inverted and upright image through the sighting telescope ZF as a receiver of the amplified image radiation of the night vision attachment ZSV or through the telescope eyepiece 4a.

FIG. 2 shows a working example of a night vision attachment according to the invention on the basis of outlined optical components. From the diagram, it is clear how radiation passing substantially along the optical axis A1′ of the attachment objective 1′ via a low-light-level amplifier 2′ to a prism system as an optical assembly is guided by means of the prism system in the form of a Porro system of the 2^{nd} type 3′ onto the optical axis A2′. The Porro system of the 2^{nd} type 3′ is arranged between objective axis and eyepiece axis. The Porro system is in the form of a Porro prism system of the second type for image inversion and for achieving a desired beam offset between radiation entering through the attachment objective 1′ and leaving through the attachment eyepiece 4′. The arrows in FIG. 2 show the direction of the beam path.

FIG. 3 shows a sighting telescope ZF′ with night vision attachment NSV′. Telescope and attachment are mounted on a mounting rail S. The night vision attachment NSV′ has, on its housing, a rotary knob D as a first mechanical switching device, with which rotary knob D a first electronic switching device in the attachment can be actuated and hence functions of the attachment, such as the switching on and off thereof and the regulation of the amplifier part, can be set. Also shown in the figure are a first and second adjustment element 7, 7′ for adjusting a crosshair of the sighting telescope ZF′. By turning the first adjustment element 7, the crosshair is laterally displaceable, and by turning the second adjustment element 7′, it is adjustable in height. As a result of the embodiment, according to the invention, of the night vision attachment NSV′, sighting telescope ZF′ and attachment can be mounted on the same support surface of the mounting rail S. Consequently, the mounted system is more stable to applied forces than a system which does not rest along its entire length substantially directly on the mounting rail S.

FIG. 4 shows an embodiment for improved operability of the night vision attachment NSV″. Since, in arrangements having an attachment module connected in front of the sighting telescope ZF″, as shown in particular in FIG. 5, the control knob D′ as a first mechanical switching device of the module is present outside the direct range of a marksman, the marksman must, for the purpose of actuation, perform a larger and hence conspicuous movement, which endangers his safety. According to the invention, an external operating device 11 as a second mechanical switching device for actuating the first electronic switching device is therefore coordinated with the night vision attachment NSV″ , which operating device 11 can be arranged in a position conveniently accessible for the marksman. In the working example shown, the second mechanical switching device—the operating device 11—is provided in addition to the operating switch D′—as a first mechanical switching device. This redundancy in the operation constitutes additional protection in respect of damage to one of the two operating components. The actuation of the electronic switching device is effected by means of the control knob D′ or the external operating device 11, for example a rotary knob or pushbutton, which is connected to the electronic switching device by means of a cable 12. Here, the cable 12 winds in a spiral around the sighting telescope ZF″.

The advantage of the mounting of a night sighting telescope NZF as explained above is further shown in FIG. 5. The night sighting telescope NZF fixed on a rail and comprising sighting telescope and night vision attachment from FIG. 3 is mounted here as a sighting device on a gun. The gun has a housing G with snapped-in magazine M, a shoulder support 8 with thumb hole 9 and a barrel R. The barrel R is inserted into the sleeve H of the housing G and screwed to said sleeve. The night sighting telescope NZF is mounted on the barrel R, the mounting shown being purely by way of example. However, it is evident from the figure that the system is compact and convenient as a result of mounting sighting telescope and night vision attachment very close to the housing G and in substantially the same support plane. Consequently, the operation of the hand-holdable firearm and of the sighting device is easier for a marksman and also a system which is stable to applied forces occurring, for example, on shooting is provided.

FIG. 6 shows a further working example of a night sighting telescope NZF′ on a gun, in this case an assault rifle SG. The assault rifle SG is supported on a bipod 10 so that a marksman who is crouching or lying under cover on the ground can conveniently operate the gun. The night sighting telescope NZF′ mounted by means of a mounting rail S′ on the gun has, analogously to the working example from FIG. 4, an external mechanical switching device for operating the electronic switching device of the night vision attachment. A cable connection exists between the operating switch 11′ representing the external mechanical switching device and the electronic switching device of the night vision attachment. Alternatively to the working example from FIG. 4, the cable 12′ is led along the mounting rail S′ and the gun and is fixed by means of clips. For flexible positioning of the operating switch 11′, the cable 12′ is coiled several times. The cable can of course also be taut. The operating switch 11′ is mounted on the assault rifle SG in a position readily accessible for the marksman. The external mechanical operating device is advantageously arranged away from the attachment housing—from the housing end on the attachment eyepiece side—by distance corresponding at least to the longitudinal dimension of the sighting telescope.

A working example of an external mechanical switching device is shown in FIG. 7. The external mechanical switching device—“remote control”—is in the form of rotary switch 11a. By means of the rotary switch 11a, the intensity of the image amplified in the low-light-level amplifier of the night vision attachment can be regulated and the low-light-level amplifier can be switched on and off. A fixing component 11a′ for fixing—for example on the gun—is coordinated with the rotary switch lla. The rotary switch lla is formed in such a way that it can be fixed and conveniently operated in all angular positions between 0° and 360°. Consequently the mounting position of the rotary switch 11a can be adapted to respective gun types, gun holders or preferences of the marksman. The operating switch lla can also be arranged on the right or left of the night sighting telescope or gun. The arrangement can be effected on the gun, for example close to the trigger, or close to the marksman, or directly on the marksman, for example on his shoulder or hip strap.

The external mechanical switching device according to the invention is shown in the figures in association with the night vision attachment according to the invention. However, the external mechanical switching device according to the invention is of course also suitable for alternative night vision attachments.

A further working example of an external mechanical switching device according to the invention is shown in part-figures 8A and 8B. FIG. 8A shows a pressure and rotary switch 11b as an operating device of the electronic switching device of the night vision attachment in plan view, and FIG. 8B shows the pressure and rotary switch 11b in partial side view and partial plan view. By pressing the switch, the function of switching on can be activated; by pressing again, the function of switching off can be activated. On turning the switch, the amplifier power of the radiation amplifier of the night vision attachment can be continuously adjusted. The switch can also be formed for stepwise adjustment. Thus, the amplification of the intensity of the radiation received in the night vision attachment can be adapted to different vision conditions. The pressure and rotary switch 11b can be connected via a cable 12b to the electronic switching device in the night vision attachment. If required, communication via a cordless connection can also be realized. The rotary and pressure switch 11b of part—FIGS. 8A and 8B furthermore has a hollow housing which is formed for threading through a carrier element, for example a belt 13, with the result that a captive connection can be produced.

FIG. 9 shows, on the basis of an outlined marksman 14, a carrying facility for an operating element 11c as a mechanical switching device according to the invention for an electronic switching device of a night vision attachment. The marksman wears a shoulder strap 13a on which the operating element 11c is mounted; for example the strap is drawn through the operating element 11c, as shown in the embodiment of FIGS. 8A and 8B, or the operating element 11c is simply pushed onto the strap. The operating element 11c can also be mounted on a hip strap. The marksman 14 can also wear the operating element 11c on the right or left, for example depending on whether he is a right-handed or left-handed marksman.

We claim:

1-9. (canceled)

10. A night vision attachment for use with a firearm on which is mounted a sighting telescope having a telescope objective lens and a telescope eyepiece arranged on a telescope optical axis, said attachment comprising a housing supporting an attachment objective lens for receiving radiation from a source thereof and passing said radiation along an attachment first optical axis substantially parallel to said telescope optical axis to a low-light-level amplifier for amplifying radiation passed by said attachment objective lens, an optical assembly for receiving amplified radiation from said amplifier and passing said amplified radiation to an attachment eyepiece supported by said housing along an attachment second optical axis substantially coincident with said telescope optical axis, and means for removably mounting said attachment housing on said firearm forwardly of said sighting telescope and in such position that amplified radiation passing said attachment eyepiece passes to said telescope objective lens.

11. The attachment according to claim 10 wherein said optical assembly comprises an image inversion system.

12. The attachment according to claim 10 or 11 wherein said optical assembly comprises prism means.

13. The attachment according to claim 12 wherein said prism means comprises a Porro prism system of the 2nd type.

14. The attachment according to claim 10 wherein said optical assembly is between said amplifier and said attachment eyepiece.

15. The attachment according to claim 10 including control switching means for switching said attachment on and off and regulating said amplifier.

16. The attachment according to claim 15 wherein said switching means is electrical.

17. The attachment according to claim 15 wherein said switching means is mechanical.

18. The attachment according to claim 17 wherein said switching means comprises a pressure switch.

19. The attachment according to claim 17 wherein said switching means comprises a rotary switch.

20. The attachment according to claim 15 wherein said switching means is mounted on said housing.

21. The attachment according to claim 14 wherein said switching means is spaced from said housing a distance corresponding substantially to the longitudinal dimension of said sighting telescope.

22. A night vision attachment for use with a firearm on which is mounted a sighting telescope having a telescope objective lens and a telescope eyepiece arranged on a telescope optical axis, said attachment comprising a housing, an attachment objective lens supported by said housing for receiving radiation from a source thereof and passing said radiation along an attachment first optical axis offset from and substantially parallel to said telescope optical axis to a low-light-level amplifier supported by said housing for amplifying radiation passed by said attachment objective lens, means supported by said housing for receiving amplified radiation from said amplifier and deflecting said amplified radiation from said attachment first optical axis to an attachment second optical axis within said housing and substantially coincident with said telescope optical axis, and means for removably mounting said attachment housing on said firearm forwardly and independently of said sighting telescope.
